(19) United States
(12) Patent Application Publication
(10) Pub. No.: US 2002/0046863 A1
(43) Pub. Date: Apr. 25, 2002

(54) Electric wiring harness sheath, corresponding assembly and corresponding door and module

(76) Inventor: Yves Heranney, Montbeliard (FR)

Correspondence Address: SUGHRUE, MION, ZINN,, MACPEAK & SEAS, PLLC, 2100 Pennsylvania Avenue, N.W., Washington, DC, 20037-3202, US

(21) Appl. No.: 09/823,273

(22) Filed: Apr. 2, 2001

(30) Foreign Application Priority Data
Apr. 4, 2000 (FR) 00 04300

(51) Int. Cl. H02G 3/14

(52) U.S. Cl. 174/65 G

(57) ABSTRACT

This electric wiring harness sheath (10) for a flat electric wiring harness of a motor vehicle door module is intended to lie, according to the shape of the door lining (4), against this door lining. The sheath (10) comprises at least two first areas (63) with high rigidity lying against more or less straight parts (30, 32, 34) of the lining, these being connected by a second area (62) with lower rigidity lying against a bent part of the lining, the second area forming a hinge when the sheath is fitted. The rigidity of the first and second areas is high enough for the sheath to more or less maintain its shape under the effect of its self-weight when its cross section is arranged more or less vertically.

The present invention relates to an electric wiring harness sheath for a flat electric wiring harness of a motor vehicle door module, this harness connecting electric components of the module to a corresponding vehicle body harness, the sheath comprising a sleeve and having, at a body end, means for fixing the sheath to the body and, at a door end, means for fixing the sheath to the module, the sheath being intended to lie, according to the shape of the door lining, against this door lining.

The state of the art already provides motor vehicle door modules comprising electric components, for example window lifter motors or door-locking electromagnets.

Each of the components has individual electric wires to power and/or control it. The individual electric wires of the various components are connected at one end, parallel to one another, in the form of a flat and flexible electric wiring harness.

The flexible wiring harness is fixed to the surface of the module by, for example, bonding. Part of the wiring harness projects toward the front of the module and carries a connector at its end.

Once fitted, the wiring harness runs between a pressing formed in the front interior lining of the door and the exterior surface of the module. The wiring harness connector is connected to a complementary connector belonging to a vehicle body electric wiring harness which, for example, connects it to the switches used to control the electric components.

A module such as this is fitted as follows.

The module is offered up to the inside of the door, parallel to the plane thereof.

At the same time, the fitter has to make sure that the projecting part of the flexible wiring harness does not fold inward, that is to say to ensure that it projects at the front of the front lining when the panel is laid against the lining.

It has been found that the longer the projecting part of the wiring harness, the greater the risk of folding. Such a module is therefore complicated to fit.

It is an object of the invention to alleviate this drawback and to make motor vehicle door modules easier to fit.

To this end, a subject of the invention is a sheath as mentioned at the start, characterized in that it comprises at least two first areas with high rigidity lying against more or less straight parts of the lining in the fitted state, these being connected by a second area of lower rigidity lying against a bent part of the lining in the fitted state, the second area forming a hinge when the sheath is fitted on the door lining, and in that the rigidity of the first and second areas is high enough for the sheath to more or less maintain its shape under the effect of its selfweight when its cross section is arranged more or less vertically.

According to some particular embodiments, the invention may have one or more of the following features:

the second area has grooves formed in the exterior surface of the sheath transversely with respect to the longitudinal axis thereof,

the sleeve is made of an elastomeric material,

it comprises a temporary holding plate made of rigid material, preferably of rigid plastic, fixed to the broad side of the sleeve, facing toward the lining in the fitted state, and said second area has grooves formed transversely in the plate,

the grooves in the plate lie facing the grooves in the sleeve,

it comprises a first sealing lip which lies on the front surface of the module in the fitted state, said first sealing lip extending around the surface of three sides of the sheath, the remaining side of the sheath being the broad side lying against the door lining in the fitted state,

it comprises a second sealing lip arranged on the exterior surface of the sheath near the body end, said second sealing lip being more or less dishshaped, open toward the body end, and the means for fixing the sheath to the body are fixing means which press said second sealing lip against the body,

the means of fixing the sheath to the body comprise at least one fixing member collaborating, through complementary shapes, particularly by snapfastening, with the body, and this member is made of a material that is more rigid than the basic material of the sheath, preferably a thermoplastic material,

the body end of the sheath is overmolded around at least part of the fixing member,

the sheath further comprises means for connecting the sheath to the door lining,

the connecting means comprises studs arranged on the broad side of the sheath and formed integrally with the sheath.

the means for connecting the sheath to the lining comprise a yoke, preferably fixed to the sheath, and extending around the opposite side of the sheath to the lining, and the yoke comprises at least one member collaborating in snap-fastening with the lining and facing toward the lining,

the sheath comprises, on its door end, a tab projecting in the direction of opening of the sheath, and the tab on its exterior surface has at least one stud for immobilizing the harness with respect to the sheath, which stud is arranged laterally with respect to the harness, the stud preferably being formed integrally with the sheath.

Another subject of the invention is an assembly of a sheath as aforementioned and of a flat electric wiring harness, in which the electric wiring harness comprises at least one lateral projection which has a hole which collaborates with an immobilizing stud.

Furthermore, a subject of the invention is a motor vehicle door module comprising a sheath of the aforementioned type or comprising an assembly of the aforementioned type.

The door end of the sheath may in particular be accommodated in a recess of the module, the depth of which is more or less equal to the thickness of the sheath.

Another subject of the invention is a motor vehicle door comprising a sheath of the aforementioned type.

The invention will be better understood from reading the description which will follow, given solely by way of example and made with reference to the appended drawings, in which:

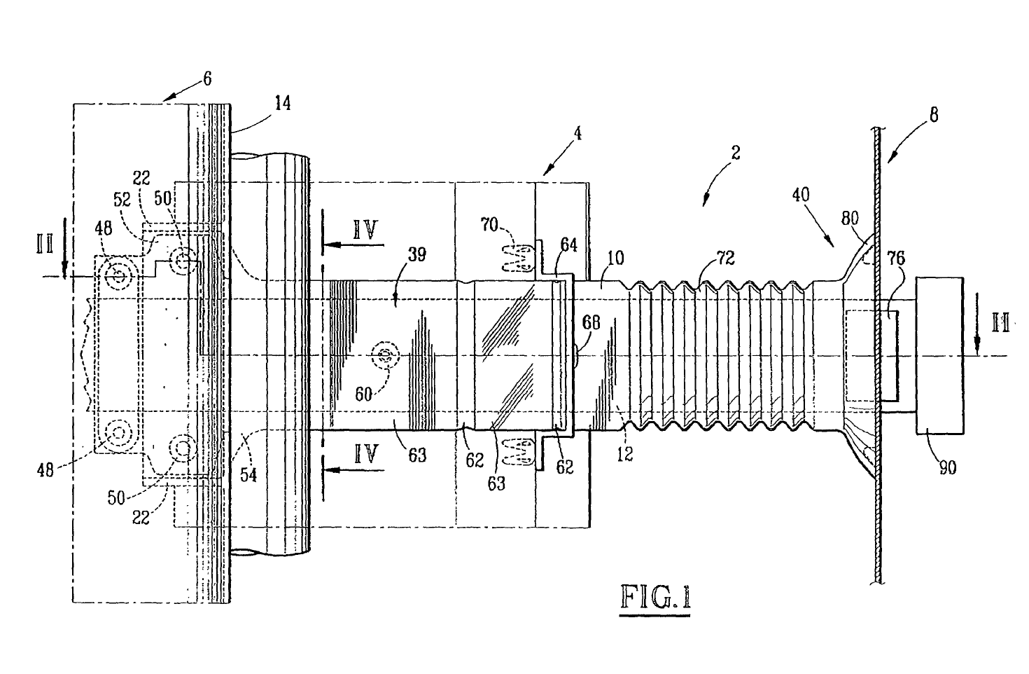

FIG. 1 is a side view of an electric wiring harness sheath assembly according to the invention, in the fitted state;

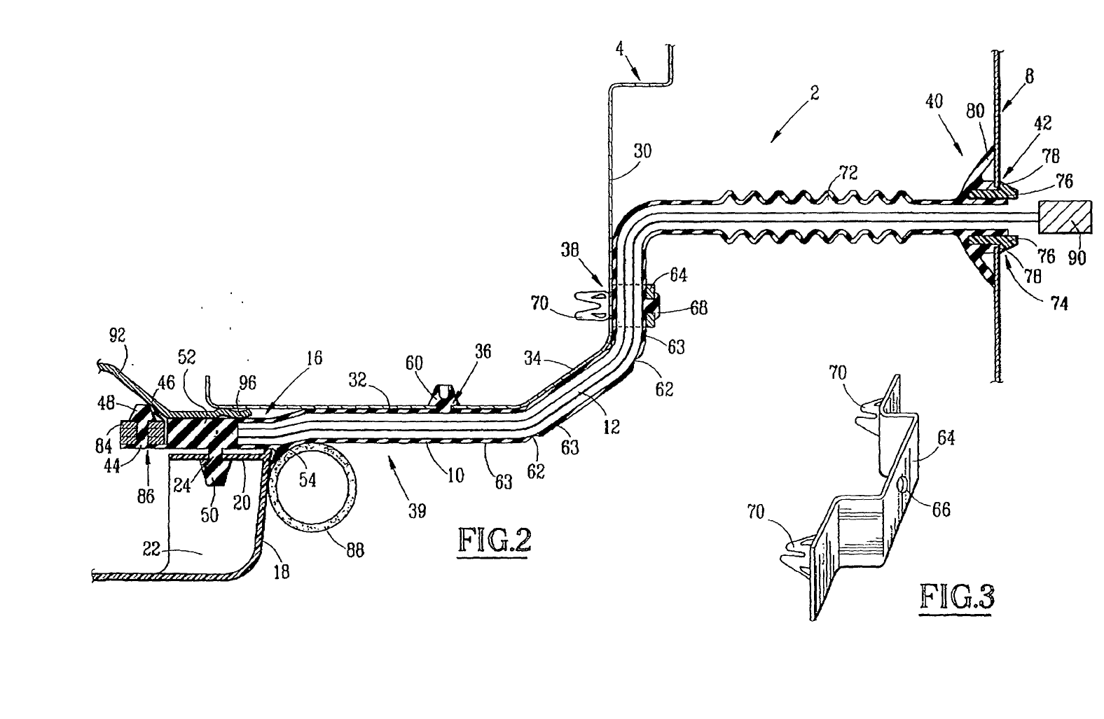

FIG. 2 is a view in section on II-II of FIG. 1;

FIG. 3 is a perspective view of a fixing yoke;

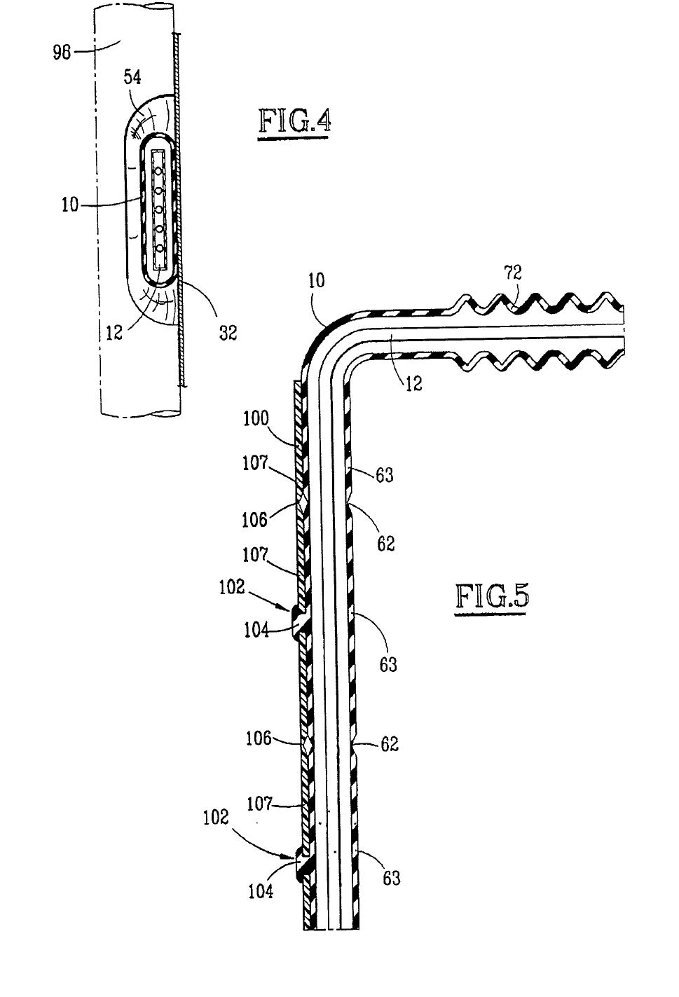

FIG. 4 is a view in section on IV-IV of FIG. 1;

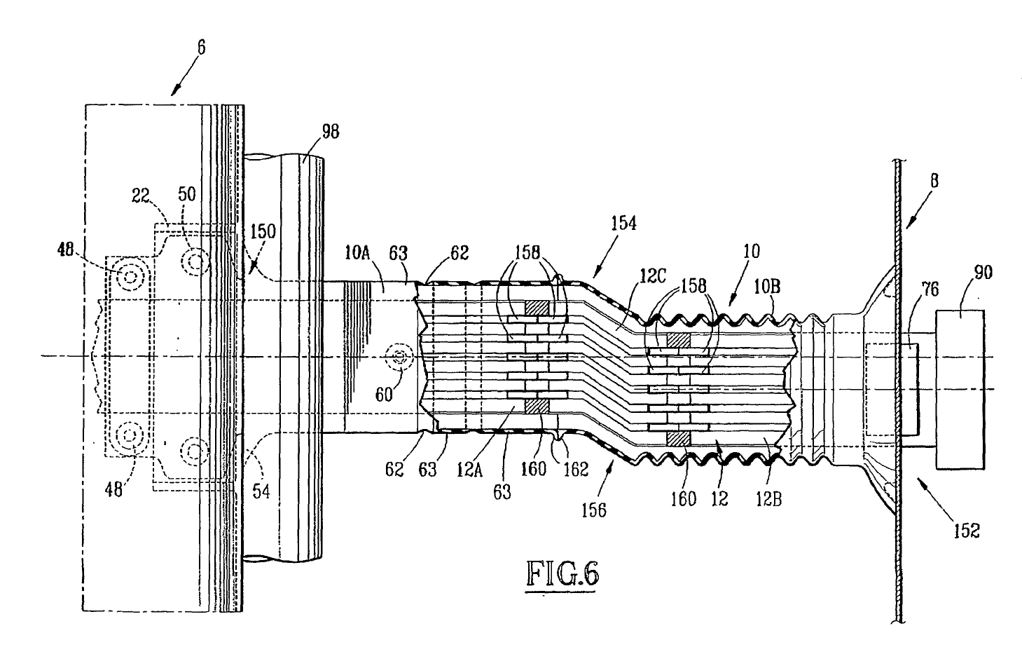

FIG. 5 is a view in section of an alternative embodiment of the invention in the unfitted state; and

FIG. 6 is a side view of a second embodiment of the invention which corresponds to the view of FIG. 1 with part in section.

FIG. 1 depicts a detail of a motor vehicle door, depicting an electric wiring harness sheath assembly 2 according to the invention.

The expressions front, rear, exterior and interior are used in what follows with respect to the vehicle when the door is closed.

FIG. 1 shows part of the front side door lining 4, part of a door module 6 fixed to the interior part of the door, and part of the vehicle body 8, together with an assembly of a sheath 10 and of an electric wiring harness 12 in the form of a flat ribbon.

The door module 6 comprises the door interior panel 14 and is fixed in the conventional way to the interior part of the door. The module 6 covers part of the side lining 4 which faces toward the inside of the vehicle when the door is closed (FIG. 2). The door module 6 has a recess 16 formed in its front wall 18, which acts as a passage for the sheath 10.

This passage recess 16 has a shape which in cross section complements that of the sheath 10.

At the site of the passage recess 16, a fixing tab 20 projects backward from the front wall 18 of the module, and parallel to the door. This tab 20 is strengthened by two ribs 22. Two sheath-fixing holes 24 are formed in this tab 20.

The door lining 4 has a lining front wall 30 running more or less vertically and at right angles to the plane of the door. The lining 4 also has a lining interior wall 32 which runs more or less parallel to the plane of the door.

The two walls of the lining are connected to one another by a lining intermediate wall which 34 runs at an angle of 45° with respect to the aforementioned two lining walls 30, 32.

The interior wall 32 comprises a first sheath-fixing hole 36 and the front wall 30 has two second fixing holes 38.

The electric wiring harness sheath 10 made of rubber or some other elastomeric material runs from the space formed by the module 6 and the door, through the passage recess 16, horizontally forward. Its cross section, in the overall shape of a flattened rectangle, is arranged more or less vertically. The sheath comprises a sleeve 39 surrounding the electric wiring harness 12.

The sheath 10 lies along the front part of the interior wall 32, on the lining intermediate wall 34 and on the interior part of the front wall 30. At this location, it is bent through 90° and runs from there, forward, parallel to the door. The front end 40 of the sheath is fixed to a recess 42 made in the body 8 of the vehicle.

A projection 44 formed integrally with the sheath 10 runs backward from the rear edge 46 thereof. This projection 44 has two immobilizing studs 48 on its exterior surface to immobilize the electric wiring harness 12.

The sheath 10 is fixed to the door module 6 by two studs 50 located on the interior surface of a connecting flange 52 of the sheath. They are formed integrally therewith and collaborate with the fixing holes 24 in the module.

The sheath 10 further comprises a sealing lip 54 which in the fitted state lies against the front wall 18 of the module. This lip 54 extends from three sides of the sheath 10, the exterior side, that is to say the side facing toward the interior wall 32 of the lining, having no lip (see FIG. 4).

A fixing stud 60 similar to the studs 50 for fixing to the module is arranged on the exterior surface of the sheath 10 and collaborates with the fixing hole 36 in the interior wall 32.

The sheath 10 also has two grooves 62 formed in its exterior surface and running all around the sheath. The grooves 62 have a flexural rigidity which is lower than that of the high-rigidity adjacent parts 63 of the sheath 10, and they form film hinges at the time of fitting.

The part of the sheath 10 which lies against the front wall 30 is fixed against the latter by a fixing yoke 64, made of plastic and depicted in FIG. 3. This yoke has a connecting hole 66 which collaborates with a T-shaped projection 68 of the sheath. It further comprises snap-fastening nibs 70 collaborating with the fixing holes 38 in the front wall 30.

The part of the sheath 10 which lies between the front wall 30 and the body 8 has a part forming a bellows 72 so as to allow the sheath 10 to flex when the door is opened and closed. The sheath 10 is fixed to the body 8 by snap-fastening means 74. These means 74 comprise two plates 76, preferably made of thermoplastic, which in cross section are in the shape of a hook 78. The body end 40 of the sheath is overmolded around the plates 76 so that the hooks 78 project from the front end of the sheath 10.

A sealing lip 80 extends around the body end 40 of the sheath and lies against the sheet metal of the body 8. This lip 80 is pressed by the hooks 78.

The electric wiring harness 12 is arranged inside the sheath 10. An immobilizing flange 84 projects laterally from the harness 12. Two holes 86 formed in this flange 84 collaborate with the studs 48 that immobilize the sheath.

It is to be noted that the harness 12 can move freely with respect to the sheath 10 along the entire remainder of the length thereof.

The wiring harness 12 has a connector 90 at its vehicle body end. In the fitted state, this connector 90 is connected to a complementary body sector (not depicted).

A proofing sheet 92 is located between the module 6 and door lining 4 and stretches between the sheath 10 and the lining 4. The edge 96 of the proofing sheet is corrugated so as to enhance the sealing effect by being clamped between two surfaces.

A door frame seal 98 lies, when the door is closed, against the long side of the sealing lip 54 of the sheath.

The wiring harness and the sheath are fitted as follows.

First of all, the electric wiring harness 12 is slipped into the sheath 10 from the door side thereof. The connector 90 is then fixed to the body end of the electric wiring harness 12 protruding from the sheath 10. Next, the holes 86 in the harness immobilizing flange 84 are slipped over the immobilizing studs 48 of the sheath.

Next, the door end of the sheath 10 is fixed to the module 6 by pushing the fixing studs 50 into the fixing holes 24 in the module, and the electric components are connected to the individual wires of the harness.

The exterior side of the module 6 is then covered with the proofing sheet 92, which is bonded to the edge of the module and over the exterior surface of the sheath 10 in the conventional way.

Next, the module 6 is fitted on the interior side of the door, firstly by positioning parallel to the overall plane of the door and then by a movement perpendicular to the plane of the door, until the module 6 and the sheath 10 are lying against the interior lateral wall of the lining 4. By virtue of the rigidity of the free part of the sheath 10, the sheath 10 more or less maintains its initial shape during the manipulating operation, at least when the module 6 is positioned vertically. In consequence, the danger of the sheath folding toward the inside during the manipulation is diminished, and fitting is easier.

The sheath 10 is fixed to the lining interior wall by pushing the fixing stud 60 into the corresponding fixing hole 36 in the lining 4.

The middle part of the sheath 10 is then laid against the lining intermediate wall 34 and against the front wall 30. The sheath is fixed to the latter by snap-fastening the fixing yoke 64. These fitting operations are easy because of the film hinges 62 formed in the sheath 10.

Finally, the body end 40 of the sheath is fixed to the sheet metal of the body 8 by snap-fastening the hooks 76 into the recess 42 of the body.

The fact that the two plates with hooks 76 are connected only by some elastomeric material makes the end 40 of the sheath easier to deform during this operation.

In addition, given that the downward flexing of the end of the sheath 40 is practically nonexistent, this end is more or less level with the recess in the body.

The wiring harness connector 90 can now be connected to the complementary connector on the body.

The sheath 10 according to the invention allows easy frontal fitting of the module 6 on the lining 4.

In addition, given that the sheath 10 itself remains in a given position, the module is easy to store.

Fixing the sheath 10 using integrally formed studs is easy and inexpensive.

FIG. 5 shows a detail of an alternative form of the sheath 10 according to the invention.

This detail depicts the part of the sheath 10 which is intended to lie against the lining interior wall 32, the lining intermediate wall 34 and the lining front wall 30, and part of the bellows 72, in the unfitted state.

A strengthening plate 100 is arranged on the outside of the sheath 10, which is the side facing toward the lining 4 in the fitted state. This plate 100 is made of a rigid plastic, for example polyethylene.

The plate 100 is fixed to the sheath 10 by two holes 102 formed in the plate, collaborating with two T-shaped projections 104, in a similar way to the way in which the fixing yoke 64 in Figure three is fixed to the sheath.

Furthermore, the plate 100 has two grooves 106 forming film hinges on its interior surface, which lie against the sheath 10. They delineate three high-rigidity areas 107 of the plate. The grooves 106 lie facing the grooves 62 in the sheath.

When the module is fitted, this plate 100 keeps the corresponding part of the sheet 10 straight and as the sheath 10 is laid against the lining 4, the fitter bends the individual parts of the plate 100 to lay them against the lining 4. The rigidity of the strengthened parts of the sheath is thus further improved and the danger of folding during fitting is reduced.

FIG. 6 depicts a second embodiment of the sheath according to the invention.

This figure corresponds to FIG. 1, with part in section. In what follows, only the differences from the first embodiment will be described.

In order to take account of a vertical offset between the exit 150 of the harness from the door and the location of the wiring harness connection 152 on the body 8, the wiring harness 12 and the sheath 10 have bent parts 154, 156.

The electric wiring harness 12 is made in three parts, two straight parts 12A, 12B and a part 12C with a double bend. The electric wires 158 project from the ends of these parts and butt together. Each of the straight parts of the harness 12A, 12B is connected to the associated end of the bent part 12C by a compact clip 160.

The wiring harness sheath 10 is made of two parts 10A, 10B each having a connecting flange 162. The two parts are connected by welding the flanges together.

The sheath is fitted as follows.

First of all, the bent part 12C of the harness is connected to the body part 12B of the harness by means of the corresponding contact clip 160. Next, this assembly is slipped into the body part 10B of the sheath, which correspondingly has a shape which is bent in its plane.

The door part 12A of the wiring harness is then slipped into the corresponding part 10A of the sheath and is immobilized by pushing the immobilizing studs 48 into the holes 86 in the immobilizing flange.

Finally, the two parts of the wiring harness 12A, 12C are connected using a second connecting clip 160 and the two parts of the sheath 10A, 10B are connected by welding the flanges 162 together.

The way in which the sheath/wiring harness assembly is fitted is analogous to the fitting in the first embodiment.

1. Electric wiring harness sheath for a flat electric wiring harness of a motor vehicle door module (6), this harness (12) connecting electric components of the module (6) to a corresponding vehicle body harness, the sheath (10) comprising a sleeve (39) and having, at a body end (40), means (74) for fixing the sheath (10) to the body (8) and, at a door end, means for fixing the sheath (10) to the module, the sheath (10) being intended to lie, according to the shape of the door lining (4), against this door lining, characterized in that it comprises at least two first areas (63; 63, 107) with high rigidity lying against more or less straight parts (30, 32, 34) of the lining (4) in the fitted state, these being connected by a second area (62; 62, 106) of lower rigidity lying against a bent part of the lining (4) in the fitted state, the second area (62; 62, 106) forming a hinge when the sheath (10) is fitted on the door lining (4), and in that the rigidity of the first and second areas is high enough for the sheath (10) to more or less maintain its shape under the effect of its self-weight when its cross section is arranged more or less vertically.

2. Sheath according to claim 1, characterized in that said second area has grooves (62) formed in the exterior surface of the sheath (10) transversely with respect to the longitudinal axis thereof.

3. Sheath according to claim 1, characterized in that the sleeve (39) is made of an elastomeric material.

4. Sheath according to claim 3, characterized in that it comprises a temporary holding plate (100) made of rigid material, preferably of rigid plastic, fixed to the broad side of the sleeve (39), facing toward the lining in the fitted state, and in that said second area has grooves (106) formed transversely in the plate

5. Sheath according to claim 4, characterized in that the grooves (106) in the plate (100) lie facing the grooves in the sleeve (39).

6. Sheath according to claim 1, characterized in that it comprises a first sealing lip (54) which lies on the front surface (18) of the module in the fitted state, said first sealing lip (54) extending around the surface of three sides of the sheath (10), the remaining side of the sheath being the broad side lying against the door lining (4) in the fitted state.

7. Sheath according to claim 1, characterized in that it comprises a second sealing lip (80) arranged on the exterior surface of the sheath (10) near the body end (40), said second sealing lip (80) being more or less dish-shaped, open toward the body end, and in that the means (74) for fixing the sheath to the body are fixing means which press said second sealing lip (80) against the body (8).

8. Sheath according to claim 1, characterized in that the means (74) of fixing the sheath to the body comprise at least one fixing member (78) collaborating, through complementary shapes, particularly by snapfastening, with the body, and in that this member (78) is made of a material that is more rigid than the basic material of the sheath (10), preferably a thermoplastic material.

9. Sheath according to claim 8, characterized in that the body end (40) of the sheath is overmolded around at least part of the fixing member (78).

10. Sheath according to claim 1, characterized in that the sheath (10) further comprises means (60, 64) for connecting the sheath to the door lining (4).

11. Sheath according to claim 10, characterized in that the connecting means comprise studs (60) arranged on the broad side of the sheath (10) and formed integrally with the sheath (10).

12. Sheath according to claim 10, characterized in that the means for connecting the sheath to the lining comprise a yoke (64), preferably fixed to the sheath, and extending around the opposite side of the sheath (10) to the lining (4), and in that the yoke (64) comprises at least one member (70) collaborating in snap-fastening with the lining (4) and facing toward the lining (4).

13. Sheath according to claim 1, characterized in that the sheath (10) comprises, on its door end, a tab (44) projecting in the direction of opening of the sheath (10), and in that the tab (44) on its exterior surface has at least one stud (48) for immobilizing the harness with respect to the sheath, which stud (48) is arranged laterally with respect to the harness, the stud (48) preferably being formed integrally with the sheath (10).

14. Assembly of a sheath according to claim 13 and of a flat electric wiring harness, characterized in that the electric wiring harness (12) comprises at least one lateral projection (84) which has a hole (86) which collaborates with an immobilizing stud (48).

15. Motor vehicle door module comprising a sheath according to claim 1.

16. Module according to claim 15, characterized in that the door end of the sheath (10) is accommodated in a recess (16) of the module, the depth of which is more or less equal to the thickness of the sheath (10).

17. Motor vehicle door module comprising a sheath (10) [lacuna] claim 1.
